(19) United States
(12) Patent Application Publication
(10) Pub. No.: US 2007/0254630 A1
(43) Pub. Date: Nov. 1, 2007

(54) Methods, devices and modules for secure remote access to home networks

(75) Inventors: Seamus Moloney, Riihimaki (FI); Vlad Stirbu, Tampere (FI); Jose Costa-Requena, Helsinki (FI); Jukka Parkkinen, Oulu (FI); Mikko A. Hyvarinen, Oulu (FI); Kari Kaarela, Oulu (FI); Kirmo Koistinen, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/785,718

(22) Filed: Apr. 19, 2007

Related U.S. Application Data
(60) Provisional application No. 60/794,096, filed on Apr. 24, 2006.

(51) Int. Cl. H04M 3/16

(52) U.S. Cl. 455/410

(57) ABSTRACT

A method, a terminal, and a server are provided to enable to remotely and securely grant, by an owner of a server, access to the server for a third party. A mechanism is defined to establish a trust relationship between a mobile device and a home gateway while in a home network and later to use that trust relationship when granting access to the home network (via remote access through the home gateway) to other devices.

### CROSS REFERENCE TO RELATED APPLICATION

This application claims priority of U.S. Provisional Patent Application Ser. No. 60/794,096 entitled, “Methods, Devices and Modules for Secure Remote Access to Home Networks,” filed on Apr. 24, 2006, the entire contents of which are incorporated herein by reference.

### FIELD OF THE INVENTION

The present invention relates to methods, devices and modules for secure remote access to home networks.

### BACKGROUND OF THE INVENTION

The use of consumer electronic (CE) devices is widely spreading in recent years. Examples of such CE devices are for example mobile phones with additional functionalities such as MP3© players and/or FM (frequency modulation) radios and/or (video/still picture) cameras. Other examples comprise such devices without the mobile phone capability and may e.g. reside in a server accessible by LAN (local area network) or WLAN (wireless local area network), Bluetooth™ or any other access technology by (authorized) parties simultaneously or successively in order to share content kept on the server. Sharing content may include downloading (a copy of) such content to a terminal or other device or merely accessing the content from such a terminal. A terminal in this sense may be represented by a mobile phone as a mobile terminal or any other kind of terminal. Similarly, a mobile phone or other terminal may have a server functionality so as to e.g. share pictures at one mobile phone acting as a server with other terminals (e.g. mobile phones). In any case, CE devices may also comprise e.g. (TeleVision) TV sets or any other display equipment such as a computer monitor and/or (High Fidelity) HiFi equipment or any other audio reproducing equipment, or even a personal computer or so-called workstation, or a personal digital assistant PDA. CE devices may be associated (e.g. connected by wire or wirelessly) to a server device and reproduce content kept at the server.

As consumer electronic devices (referred to also as CE devices) become network enabled, home networking scenarios are emerging which allow content to be stored on one device in the home, referred to as server, and to be moved by a second device (acting as a controller or administrating device) to a playing device such as the above mentioned devices e.g. a TV or home HiFi system which may reproduce the content. A mobile phone is seen as an ideal example device to act as the controller in such scenarios.

Mobile devices spend a good deal of their time outside the home, so for a consistent user experience, they should be able to still access and/or control the content stored on the home media servers. Such content should not be allowed to be viewed by just anyone, so control of access to the content and a secure tunnel between the mobile device and the home are requirements or at least desirable.

“Universal Plug and Play”, UPnP™, is currently seen as a quite realistic standard for enabling interoperability between home CE devices. In the UPnP Forum, several companies have begun to work on specifying a Remote Access (RA) service for controlling the access to the home and this standard is expected to be agreed on by end of summer 2006.

“UPnP™ security” is a standard which has been in existence since 2003 and is concerned with how to secure UPnP™ interactions in a LAN environment. For example, basics of such interactions are laid down in “Device Security:1 Service Template”, and “Security Console:1 Service Template”, both of Nov. 17, 2003 and for UPnP™ Device Architecture 1.0.

In such scenarios, there needs to be a way to securely grant access to the home network to any device the home owner wishes to allow. Also, this should be possible while the home owner is at home but also while outside the home, for instance while visiting a friend.

One way for this to be feasible is for the home owner to carry a mobile device which gives a credential to the other devices as they wish to use the home network. The other user needs to be able to immediately use the credential to e.g. fetch some pictures as an example of content from that network. This would mean that the home owners mobile should immediately contact the home network gateway device and inform it to allow the granted credential to be used for access.

A major disadvantage of this is that this approach requires that the home gateway (gateways in general being also referred to by abbreviating as GW) exposes an interface to the public internet for adding credentials which are allowed for access. This interface will be subject to attacks and can seriously compromise the security of the home network.

A second problem in such scenarios is how to allow for different members of a family to set different profiles for remote access.

Still further, in the UPnP™ security model as one example of an application scenario for the present invention to be described later, there is an Access Control List (ACL), in which all the users and their permissions are listed. This list is located in the media server. Only the owner of the media server is able to modify the list using activities such as create/update/delete user accounts, give permissions to a user account and associate Control Points (CP) with user accounts. All these modifications require on-line connection between the media server and the owner/server owner's terminal device. A control point CP may be exemplified by a “friend's” user terminal, also referred to as CP user.

FIG. 1 shows in an overview a media sever associated to two different examples of control points, a security aware (SA CP) and a security unaware control point. Furthermore, actions applicable by a control point user (CP user) are indicated, and actions applicable by an owner (administrator) of the media server are indicated. The internal composition of the media server and the interactions therewith are only roughly outlined and details can be found in the above referenced UPnP™ references.

Note that UPnP™ is used as an example only and the present invention is applicable in its generality to a variety of similar or different systems, as long as such system comprises a server on which accessible content is maintained under administration of a server owner/content owner, with the content being accessible for user devices distinct from the server such as CE equipments of the above mentioned variety of types (e.g. mobile phones, or other devices) capable of reproducing the content stored on the server. Such CE user devices are connectable to the server via wire or wirelessly using a suitable technology of which examples were outlined further above.

Generally, for the purpose of the present invention to be described herein below, it should be noted that

a communication device or terminal may for example be any device by means of which a user may access a network and/or a server of such network; this implies mobile as well as non-mobile devices and networks, independent of the technology platform on which they are based; only as an example, it is noted that terminals operated according to principles standardized by the 3^{rd} Generation Partnership Project 3GPP and known for example as UMTS terminals (Universal Mobile Telecommunication System) are particularly suitable for being used in connection with the present invention, nevertheless terminals conforming to standards such as GSM (Global System for Mobile communications) or IS-95 (Interim Standard 95) may also be suitable;

networks referred to in this connection may comprise private media networks or public media networks, independent of the type of media kept in the network and the technology on which the networks are operated, for example those networks operate on the basis of the Internet Protocol IP, independent of the protocol version (IPv4 or IPv6), or on the basis of any other packet protocol such as User Datagram Protocol UDP, etc.

a communication device can act as a client entity or as a server entity in terms of the present invention, or may even have both functionalities integrated therein;

although reference was made herein before to media, this exemplifies only a specific example of “content” in general; content or media as used in the present invention is intended to mean at least one of audio data, video data, image data, text data, and metadata descriptive of attributes of the audio, video, image and/or text data, any combination thereof or even, alternatively or additionally, other data such as, as a further example, program code of an application program to be accessed/downloaded;

method steps likely to be implemented as software code portions and being run using a processor at one of the server/client entities are software code independent and can be specified using any known or future developed programming language as long as the functionality defined by the method steps is preserved;

method steps and/or devices likely to be implemented as hardware components at one of the server/client entities are hardware independent and can be implemented using any known or future developed hardware technology or any hybrids of these, such as MOS (Metal Oxide Semiconductor), CMOS (Complementary MOS), BICMOS (Bipolar CMOS), ECL (Emitter Coupled Logic), TTL (Transistor Transistor Logic), etc., using for example ASIC (Application Specific Integrated Circuit) components or DSP (Digital Signal Processor) components, as an example;

generally, any method step is suitable to be implemented as software or by hardware without changing the idea of the present invention in terms of the functionality implemented;

devices can be implemented as individual devices, but this does not exclude that they are implemented in a distributed fashion throughout the system, as long as the functionality of the device is preserved;

devices may also be implemented as a module configured to accomplish interoperability with other modules constituting an entire apparatus, e.g. a module device may be represented as a chipset or chip card e.g. insertable and/or connectable to an apparatus such as a mobile phone, or a module may be realized by executable code stored to a mobile phone or other device for execution upon invocation.

Subsequently, the description will use UPnP™ networks as an example scenario. Expressions known from UPnP™ are used as respective examples, while, however, it should be kept in mind that this is only one example scenario in which the present invention is applicable.

In the scenario according to FIG. 1, the owner of the media server is not always present in the UPnP™ network and does not always have e.g. an IP access to the media server. In such a situation, the owner is not able to modify the Access Control List ACL. There might, however, be a case that there is some friend or relative visiting the owners home and while the owner is e.g. at work, and such visitor as a control point (CP) user would like to access content, e.g. to watch movies or listen for music from the owners media server, but he/she does not have the access credentials nor the user account to the UPnP™ network at the owner's home UpnP™ network. If the owner does not have access to the server, he/she is not able to give access rights to the visitor.

However, whenever access is granted to a user of a network, in particular to a privately owned network, security issues are of utmost importance. Therefore, UPnP™ security specification defines the basic building blocks for managing the access rights etc, but there is an ongoing activity to improve the UPnP™ security-based solution for a comprehensive set of use cases for UPnP™ Audio Video.

Security considerations comprise e.g. the following aspects:

Remote Access (RA) services interface must be protected,

Prevent bad behaving/rogue users to configure RA profiles without owner consent,

Remote Access services interface must not be exposed on e.g. WAN (Wide area network) interface due to likelihood of e.g. internet based attacks,

Remote Access connection authentication must be based on strong cryptography (mere password based authentication is generally weak to dictionary attacks)

Remote Access authorizations must be flexible to enable e.g. One-time, “one period” such as one week, or even permanent access, but the server owner must be able to revoke rights at any time, while user interactions needed for setting up security must be minimal.

### SUMMARY OF THE INVENTION

Hence, it is an object of the present invention to improve the pre-existing scenarios and to enable to remotely and securely grant, by an owner of a server, access to the server for a third party.

Accordingly, according to a first aspect of the present invention, this object is for example accomplished according to the first aspect in that the invention comprises a mechanism whereby a home owner mobile device can establish a trust relationship with a home gateway while in the home, and later issue credentials to other devices outside the home. These other devices can present the credentials to the home GW and establish a secure tunnel with the home gateway GW (control point) able to verify that the credential has been issued by a home owner device.

By virtue of the present invention, as explained in connection with the first aspect, at least one of the following effects can be achieved:

The home GW access granting functionality does not need to be exposed to an external interface. This means it is not exposed to internet based attacks.

Everything can be based on the trust established between the mobile device and the home GW while in the home and that is cryptographically strong.

Uses existing standard UPnP™ (universal plug and play) security which is royalty free. A RAGW (remote access gateway) can be owned by more than one device, so it is possible for different family members to issue credentials and for the RAGW to notice which family member allowed a connecting remote access device to have access by granting the credential. This means the GW can be setup to execute a different set of filters (i.e. which parts of the home NW are allowed to be used by the remote device) based on which of the family members issued the credential to the connecting device.

Still further, according to a second aspect of the present invention, this object is for example accomplished in that according to the second aspect, access rights to e.g. UPnP™ devices such as media servers can be managed only by it's owner. Therefore, if the owner does not have access to the UPnP™ network, the user rights could be given to a guest user by sending him/her a data package from the owner's device, which includes update information to the UPnp™ device's Access Control List. The guest device forwards the package to the UPnP™ device and gets the user account to the device/network.

By virtue of the present invention, as explained in connection with the second aspect, at least one of the following effects can be achieved:

Consequently, under the second aspect of the present invention, in this use case, the present invention comprises managing the access rights remotely, e.g. off-line, which has not been addressed before in this technical field.

The Media Server user accounts, generally, any user accounts at e.g. a content server, and user permissions can be updated without having e.g. an UPnP™ network connection from the owner's device to the server device. This is easily to be accomplished by adding an application or module to the terminals of the users, whether server owner's terminal or guest terminal, which allow editing (owner) or receiving (guest) of Access Control Lists ACLs of the server, and to add a corresponding application or module to the server configured to handle a received edited ACL, which is received (from the guest device) as an encrypted data package.

Thus, in relation to the present invention, under certain sub-aspects thereof, UPnP™ Security is used, public key cryptography is used, and/or UPnP Security for RA Credential Management is re-used.

Public key cryptography also in relation to the present invention means that PKI (public key infrastructure) is used. The basic idea behind PKI is that each one of involved devices have a pair of keys: private key and public key. The keys are not the same but they are paired (which means, for a private key there is only ONE corresponding public key). The private key should never be revealed to others while public key could be delivered to others. So one could encrypt some data with one's private key. The encrypted data could be decrypted with private key or public key. Since the private key is never revealed to others, so only those who have the corresponding public key could decrypt the document. Stated in other words to express it even better, this means that Public-key based cryptography works so that if a device (A) has a keypair PubkeyA and PrivkeyA and then gives B the PubkeyA part, A can later sign data with PrivkeyA and give that (signed data) to B. B will be able to verify that the signature was really made by A based only on the PubkeyA device A gave to B earlier, although B has no knowledge of A's private key.

### BRIEF DESCRIPTION OF THE DRAWINGS

The present invention is described herein below with reference to the drawings.

FIG. 1 shows in an overview a media sever associated to two different examples of control points (user devices) together with actions applicable by a control point user (CP user and/or guest) and actions applicable by an owner (administrator) of the media server;

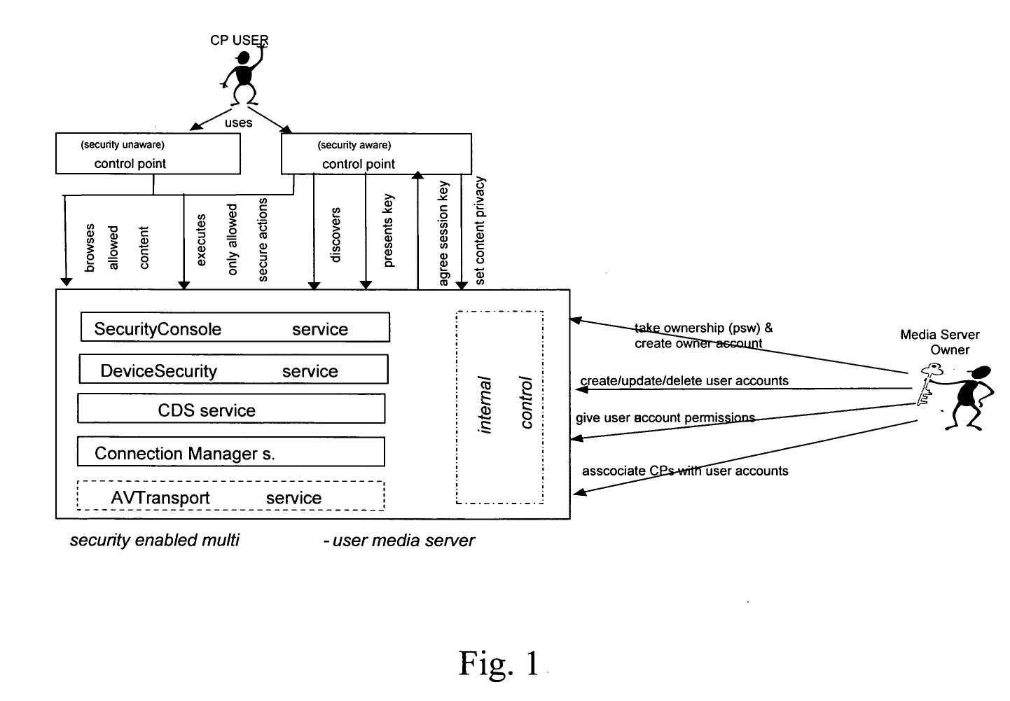

FIG. 2 is a diagram that indicates a sequence which takes place when the home owner device creates the trust chain and then later when the owner and a guest actually use this chain together;

FIG. 3 is a signaling diagram showing exchange of messages according to the second aspect of the present invention, and

FIG. 4 is a block circuit diagram showing basic components of a device such as a terminal or server device according to an exemplary embodiment.

### DETAILED DESCRIPTION OF THE DRAWINGS

The present invention is described herein below with reference to the drawings.

The invention comprises, for example, according to the first aspect, a mechanism to establish a trust relationship between a mobile device and a home GW while in the home and later to use that trust relationship when granting access to the home network (via remote access through the home GW) to other devices. In such exemplary example, the mobile device interacts with the home gateway according to the rules of UPnP™ security, thereby becoming an owner of that device. This procedure is explained below.

As part of the procedure, a home gateway GW/owners home server securely gains knowledge of the public key of the mobile device. This public key of the home owners mobile device is presented to the server e.g. in a “take ownership” signaling conformant to UPnP™. This key becomes resident on the list of owner devices (e.g. ACL, access control list) inside the home GW. An issue of this invention is to propose a scenario where the home GW configures its remote access secure tunneling module (whether in software or hardware) (tunneling being likely to be either IPSEC or TLS based) to trust all the public keys on this owner list. The tunneling module is also configured to accept certificate based access, meaning no user name and passwords can be used for remote access to the home network. (Nevertheless, if a lower security is acceptable, configuration could be such that also user name and password could be accepted for remote access.) After this step, remote devices need to present digital certificates to the home GW in order to be able to get access. A digital certificate (e.g. X509 format) consists of a public key and evidence that that public key has been signed by another public key—a signature and some identifier for the signer. In many situations this signer is a Certificate Authority. In an example implementation of this invention, the (server owner's) mobile device takes the role of certificate authority and the home GW (server) trusts any certificates which have been signed by the owner's mobile device.

The mechanism whereby other devices present their public key to the mobile device and it signs their public keys and issues them with certificates is detailed below. Such an approach is flexible as the certificates can contain attributes which determine e.g. how long the remote access should be allowed for and what kind of remote access should be allowed: e.g. the accessing device can be treated as either a family member with full access to all home devices or as a guest device with access restricted to certain devices, or with access restricted to certain content (e.g. audio only, or video only), or access restricted to certain times, or any permutation of combinations of such access restrictions.

This means that by default all devices that have the Remote Access Gateway (RAGW) functionality configures the IPsec/TLS trust chain when the Security Console (SC) of the home owner (server owner) takes ownership. This in turn will imply that the particular SC is also a Remote Access Control Point.

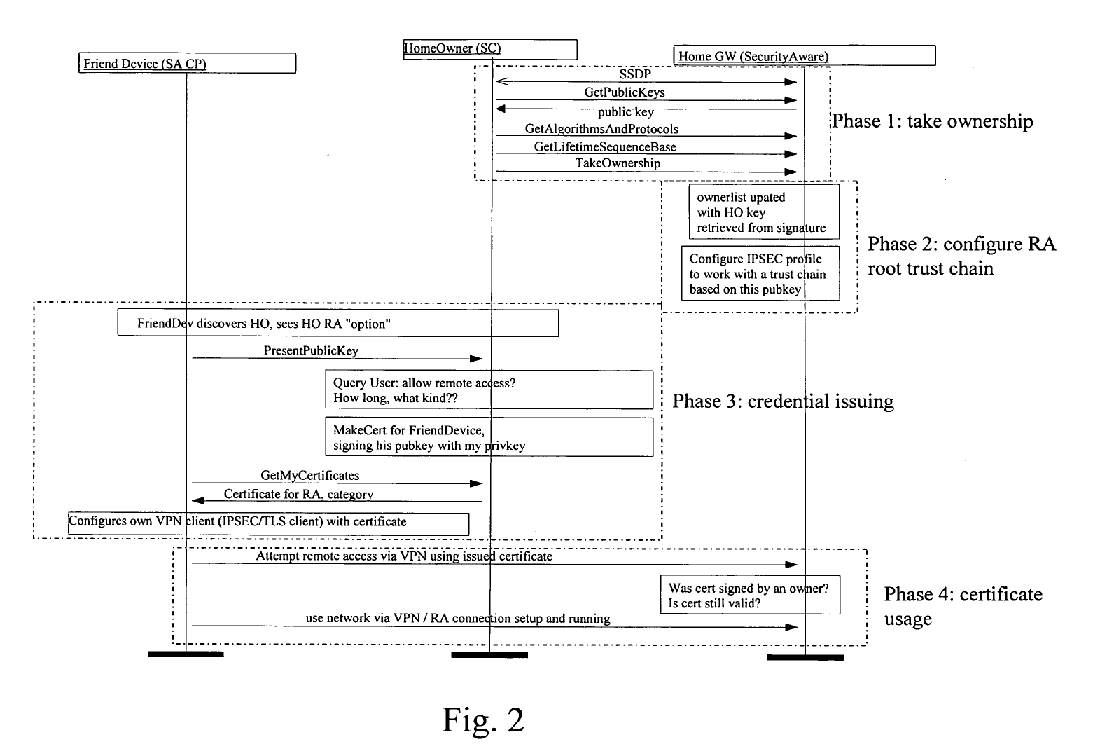

FIG. 2 is a diagram that indicates the sequence/phases which takes place when the home owner device creates the trust chain and then later when they, i.e. the devices and/or users of the devices actually use this chain.

These phases are basically described as follows:

Phase 1: TakeOwnership operation.

Using the rules of e.g. UPnP™ security, the home owner device becomes a registered owner of the Remote Access Gateway.

To this end, the home owner device discovers the GW with SSDP (simple service discovery protocol), finds gateway's public key using e.g. GetPublicKeys and gets the nonce (using e.g. GetLifetimeSequenceBase) it needs to make a valid TakeOwnership call on the RAGW (remote access gateway). (“Nonce” being formed by “Number ONCE” means an arbitrary number that is generated for security purposes such as an initialization vector. A nonce is used only one time in any security session.) This call is signed by the home owner device, so the RAGW can find out the public key of the HomeOwner Security Console.

Using e.g. GetAlgorithmsAndProtocols by the HomeOwner terminal (Security Console) enables the home owner device to find out if the RAGW supports IPSEC or TLS and the home owner device can provide this information later as part of the credentials it issues, thus enabling the receivers of the credentials to know how the type of RAGW in use tunnels datagrams to and from the RAGW.

Phase 2: RAGW Configuration operation:

The public key of the home owner device (retrieved from its signature) is entered into the OwnerList (which is an ACL) of the RAGW. The RAGW also configures its secure tunnel stack, be that IPSEC or TLS, so that secure tunneling stack recognizes the public key of the new owner device as a trusted device. This means that any certificates which are public keys of other devices signed using the private key corresponding to the public key of the server's owner (or one of them if there are several), will be accepted as valid credentials for remote access.

Phase 3: Credential issuing:

When outside the home, the home owner meets a friend or vice versa. They get their devices to form an IP network (or they communicate via an intermediate IP network or other packet based network such as UMTS, GPRS, or the like) and the home owner starts a HomeManager application, meaning he begins to behave as a UPnP security console. The friend device has a client application which is used to enroll Remote access credentials. It uses e.g. SSDP to discover the HO SC and to discover that the HO SC offers an option for remote access, and then the friend device presents its public key (i.e. of the friend device) using e.g. the PresentKey operation (e.g. as known from UPnP™ security console specifications). In order to verify that the person being sent the credential really is the friend he intends to provide it to, this operation needs to be authenticated. A hashing operation is performed on the presented public key which has been received from the friend and e.g. the first 4 digits are displayed at the home owners device. At the HO SC, this value is displayed and the user is queried via a man-machine-interface: Does the hash of the presented key match the value shown on the display of the friends device, where the same value has been calculated for display. If the home owner confirms, he is asked if the credential should be issued to the friend and optionally how long the access should be allowed for and what kind of access (friend, family, guest etc, all devices /media content or only part thereof etc). This information can be placed in the certificate extensions which are e.g. possible in X.509 certificates. The invention is not limited to be applicable with X.509 certificates but can also be used in connection with other similar certificates.

The certificate is generated by the home owner device (security console SC) and the public key of the friend device is signed by the home owner.

The friend device calls e.g. GetMyCertificates and the generated certificate is returned to the friend device. The certificate contains e.g. among others a subjectname (set to the preferred name used in the presentkey call), an issuer name (friendly name for the friend to be able to recognize what this certificate can be used for), the friend's public key and a signature of that public key. There can be an identifier also for the public key which was used to make that signature, e.g. the public key hash or the whole public key itself of the signer (Home owner device).

The friend device configures its own VPN (virtual private network) client module, be that based on e.g. IPSEC or TLS as tunneling module, with the received certificate.

Phase 4: certificate usage:

Thereafter the friend device can try to access the remote GW. The GW address is contained as information in the received certificate or alternatively even as out-of-band information (signaled in a separate message). When the friend device attempts access, the validity of the certificate will be checked at the home GW: checking comprises verifying whether

the signature was made by a known home owner?

the certificate is still valid?

If these tests pass, the access can be allowed and a secure session such as an IP (Internet Protocol) based session can take place between the friend device and the home owners home network.

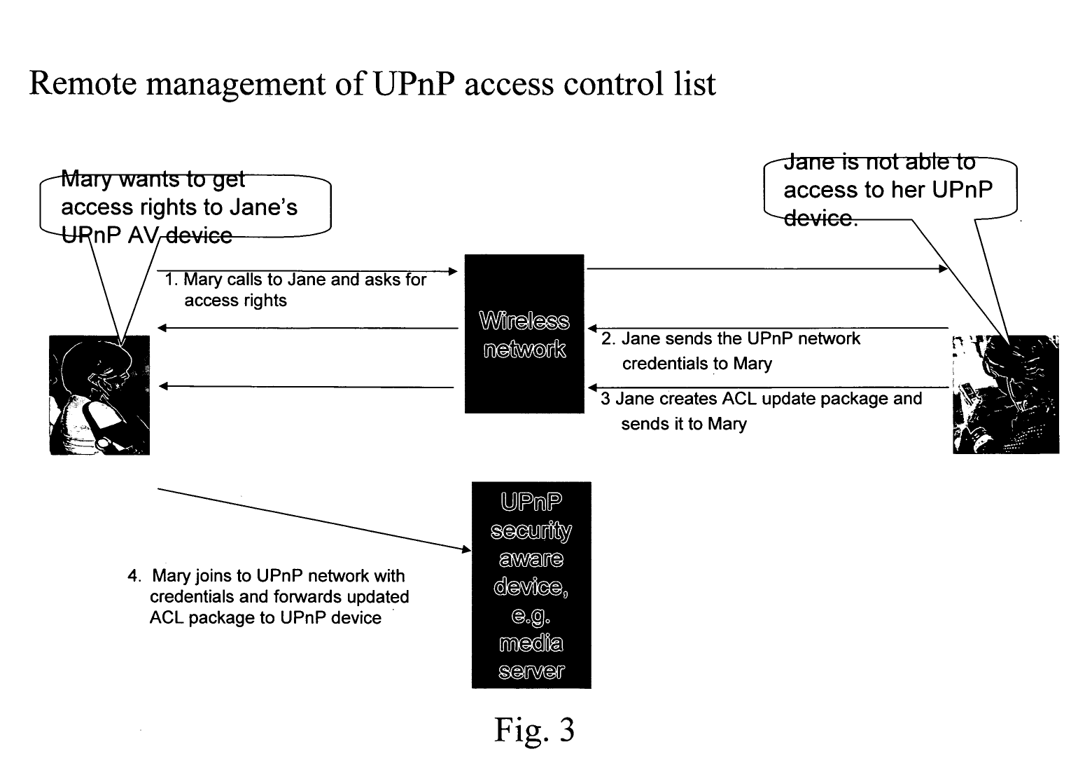

FIG. 3 is a signaling diagram showing exchange of messages according to the second aspect of the present invention. Under this aspect, the present invention comprises a method for granting rights for the new control point in the UPnP™ network in a situation where the owner does not have access to the media server.

The owner has an ACL management application in his terminal device such as a mobile phone. The application includes a replica of his media servers' ACLs (e.g. in an internal memory dedicated to this purpose or in a shared memory of the terminal in partitions of which also other data can be stored) and has an interface for editing those lists. Such an interface can be a conventional man-machine interface including a display, keyboard, pointing device such as a mouse, pen or the like.

The owner can add his visitor/friend into his off-line ACL list and specify the rights for this new account. When the list is edited and ready, the owner adds his personal authenticator (e.g. at least one of Certificate, username/password, digital signature) to the list and encrypts it with the public key of the media server.

When the list is modified, “signed” and encrypted, the owner sends the whole data package and the needed network credentials (e.g. at least server address) via e.g. a wireless network such as a GSM or UMTS network or any other wireless network to the visitor's mobile phone. The visitor's terminal uses the received credentials to connect to the UPnP network and passes the data to the media server, which upon receipt thereof decrypts the data and check's the “signature” of the owner. If the “signature” is valid the media server updates the ACL. In this phase the visitor then has the user account and the given permissions.

The visitor needs still a password for taking the media server in his control. The password could be delivered in the same data package with the edited ACL and shown on the display of the media server or sent as a separate message item to the visitor.

The password is displayed on the device to make sure that the user is present in the same room with the UPnP device. This procedure is also e.g. used when a UPnP™ device is for the first time taken into use. The new user can “use” the devices (power up), but he does not have access rights to the server content to be reproduced (“played”).

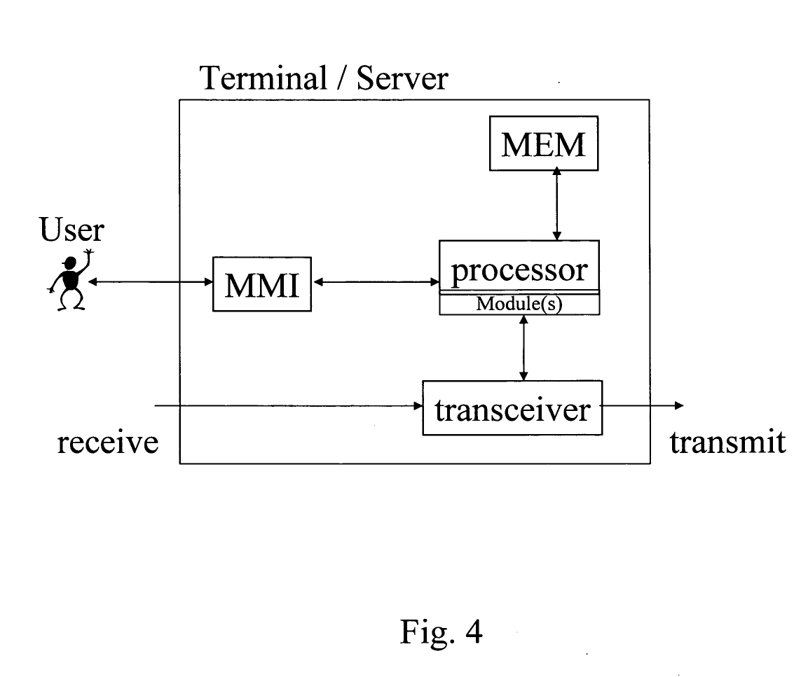

FIG. 4 is a block circuit diagram showing basic components of a device such as a terminal or server device according to an exemplary embodiment. As mentioned before, in certain embodiments, server device and terminal device can be implemented in the same physical entity.

As shown in FIG. 4, a user interacts with the device, whether server device or terminal, via a man machine interface MMI. The MMI can be any suitable interface using at least one of a mouse, pen, keyboard, microphone or the like for user input and/or using at least one of a display, loudspeaker, printer or the like for output to the user in at least one of visible, audible or tangible from. Data from other devices is input using a receiver unit of a transceiver, and data is output to other devices using a transmitter unit of the transceiver. Data input from other devices and/or from the user are supplied internally to a processor connected to a memory MEM. The processor processes the data supplied thereto according to processing instructions and stores processing results temporarily or permanently, e.g. in the memory MEM connected thereto or to an external memory (not shown). Also, the processing instructions can be stored in the memory. The memory MEM can be any suitable volatile and/or non-volatile storage medium suitable for the (electronic) processing, such as a electrically erasable programmable read only memory EEPROM, a read only memory ROM, a random access memory RAM, a harddisk, floppy disk, or compact disc CD or digital versatile disc DVD, or the like. The memory generally stores data in different partitions, possibly depending on the data type. Processing instructions are in exemplary embodiments program code, but can be in other exemplary embodiments also implemented as hardware, e.g. as processing module connectable or insertable to the device as the processor or processor module.

In an exemplary embodiment of the invention which concerns a terminal, the terminal device, i.e. the processor in cooperation with at least the memory and transceiver is configured to retrieve a public encryption key of a server device, and configured to be registered at the server device with a public key.

A scenario comprises that a tunneling mechanism for data transmission between a server device and a terminal is configured at the server device based on the public key of the terminal.

In another exemplary embodiment of the invention which concerns a terminal, the terminal device, i.e. the processor in cooperation with at least the memory and transceiver, is configured to be registered at a server device, configured to receive a request to authorize access to a requesting terminal, and configured to create an access certificate based on a public key of the requesting terminal and a private key of the registered terminal when access is authorized, and configured to inform the requesting terminal of the created access certificate to remotely authorize the requesting terminal access to the server.

According to still another exemplary embodiment of the invention which concerns a terminal, the terminal device, i.e. the processor in cooperation with at least the memory and transceiver, is configured not to be registered at a server, and configured to present an access certificate to the server, the access certificate being signed by a terminal registered, and access to the server is granted for the terminal not registered at the server. Namely, upon receipt of the access certificate, the server checks whether the access certificate is signed by a terminal registered at the server, and if so, access to the server is granted for the terminal not registered at the server.

According to still another exemplary embodiment of the invention which concerns a terminal, the terminal device, i.e. the processor in cooperation with at least the memory and transceiver, is configured to administer access to a server, configured to receive a request to authorize access to a requesting terminal, configured to create an access right for the requesting terminal when access is authorized, and configured to inform the requesting terminal of the created access right to remotely authorize the requesting terminal access to the server.

Such terminal may optionally be further configured to encrypt the access right with a public key of the server to which access is requested, and configured to authenticate the access right.

According to still another exemplary embodiment of the invention which concerns a terminal, the terminal device, i.e. the processor in cooperation with at least the memory and transceiver, is configured to retrieve a public encryption key of a server device, wherein the terminal is registered at the server device with a private encryption key and a corresponding public encryption key of the terminal, and wherein only the public encryption key is delivered to other terminals. Such terminal may optionally be further configured to sign data with the private encryption key, and configured to provide the signed data to another terminal. The other terminal verifies the signed data using only the public encryption key, where the other terminal does not include the private encryption key of the terminal.

In an exemplary embodiment of the invention which concerns a server device, the server device, i.e. the processor in cooperation with at least the memory and transceiver is configured to receive, from a terminal not registered at the server device, an access certificate, and configured to check that the access certificate is signed by a terminal registered at the server device, wherein access to the server device is granted for the terminal not registered at the server device in case the check is successful.

In another exemplary embodiment of the invention which concerns a server device, the server device, i.e. the processor in cooperation with at least the memory and transceiver is configured to receive, from a terminal not administering the server device, an access right, and configured to check that the access right is signed by a terminal administering the server device, wherein access to the server device is granted for the terminal not administering the server in case the check is successful.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed:

1. A method, comprising:
retrieving a public encryption key of a server device by the terminal; and
registering the terminal at the server device with a public key of the terminal.

2. The method according to claim 1, further comprising:
configuring a tunneling mechanism at the server device based on the public key of the terminal.

3. A method, comprising:
requesting a terminal registered at a server device to authorize access to a requesting terminal;
when access is authorized, creating an access certificate by the registered terminal based on a public key of the requesting terminal and a private key of the registered terminal; and
informing the requesting terminal of the created access certificate to remotely authorize the requesting terminal access to the server device.

4. A method, comprising:
presenting, by a terminal not registered at a server device, an access certificate to the server device;
checking, at the server device, that the access certificate is signed by a terminal registered at the server device; and
when checking is successful, granting access to the server for the terminal not registered at the server.

5. A method, comprising:
requesting a terminal administering access to a server device to authorize access to a requesting terminal,
when access is authorized, creating an access right for the requesting terminal at the administrating terminal; and
informing the requesting terminal of the created access right to remotely authorize the requesting terminal access to the server device.

6. The method according to claim 5, further comprising:
encrypting the access right with a public key of the server to which access is requested; and
authenticating the access right by the administrating terminal.

7. A method, comprising:
presenting, by a terminal not administering a server device, an access right to the server device,
checking, at the server device, that the access right is signed by a terminal administering the server device; and
when checking is successful,
granting access to the server for the terminal not administering the server device.

8. A method, comprising:
retrieving a public encryption key of a server device by a terminal; and
registering the terminal at the server device with a private encryption key and a corresponding public encryption key of the terminal, wherein only the public encryption key is delivered to other terminals.

9. The method according to claim 8, further comprising:
signing data at the terminal with the private encryption key; and
providing the signed data to another terminal, wherein the other terminal verifies the signed data using only the public encryption key, where the other terminal does not include the private encryption key of the terminal.

10. A terminal configured to retrieve a public encryption key of a server device, and configured to be registered at the server device with a public key.

11. The terminal according to claim 10, wherein a tunneling mechanism is configured at the server device based on the public key of the terminal.

12. A terminal configured to be registered at a server, configured to receive a request to authorize access to a requesting terminal, and configured to create an access certificate based on a public key of the requesting terminal and a private key of the registered terminal when access is authorized, and configured to inform the requesting terminal of the created access certificate to remotely authorize the requesting terminal access to the server.

13. A terminal configured not to be registered at a server, and configured to present an access certificate to the server, wherein the access certificate is signed by a terminal registered at the server, and access to the server is granted for the terminal not registered at the server.

14. A terminal configured to administer access to a server, configured to receive a request to authorize access to a requesting terminal, configured to create an access right for the requesting terminal when access is authorized, and configured to inform the requesting terminal of the created access right to remotely authorize the requesting terminal access to the server.

15. The terminal according to claim 14, the terminal further configured to encrypt the access right with a public key of the server to which access is requested, and configured to authenticate the access right.

16. A terminal configured to retrieve a public encryption key of a server device, wherein the terminal is registered at the server device with a private encryption key and a corresponding public encryption key of the terminal, and wherein only the public encryption key is delivered to other terminals.

17. The terminal according to claim 16, the terminal further configured to sign data with the private encryption key, and configured to provide the signed data to another terminal.

18. A server device configured to receive, from a terminal not registered at the server device, an access certificate, and configured to check that the access certificate is signed by a terminal registered at the server device, wherein access to the server device is granted for the terminal not registered at the server device in case the check is successful.

19. A server device configured to receive, from a terminal not administering the server device, an access right, and configured to check that the access right is signed by a terminal administering the server device, wherein access to the server device is granted for the terminal not administering the server in case the check is successful.

20. A terminal, comprising:
retrieving means for retrieving a public encryption key of a server device; and
registering means for registering the terminal at the server device with a public key.

21. A terminal, comprising:.
registering means for registering the terminal at a server;
receiving means for receiving a request to authorize access to a requesting terminal; and
creating means for creating an access certificate based on a public key of the requesting terminal and a private key of the registered terminal when access is authorized, wherein the requesting terminal is informed of the created access certificate to remotely authorize the requesting terminal access to the server.

22. A terminal not registered at a server, comprising:
presenting means for presenting an access certificate to the server, the access certificate is signed by a terminal registered at the server, for granting access to the server for the terminal not registered at the server.

23. A terminal, comprising:
administering means for administering access to a server;
receiving means for receiving a request to authorize access to a requesting terminal;
creating means for creating an access right for the requesting terminal when access is authorized; and
informing means for informing the requesting terminal of the created access right to remotely authorize the requesting terminal access to the server.

24. A server, comprising:
receiving means for receiving, from a terminal not registered at a server, an access certificate; and
checking means for checking whether the access certificate is signed by a terminal registered at the server, wherein access to the server is granted for the terminal not registered at the server.

25. A server, comprising:
receiving means for receiving, from a terminal not administering the server, an access right; and
checking means for checking whether the access right is signed by a terminal administering the server, wherein access to the server is granted for the terminal not administering the server.
